(19) United States
(12) Patent Application Publication
(10) Pub. No.: US 2007/0050550 A1
(43) Pub. Date: Mar. 1, 2007

(54) Techniques for dynamically selecting an input buffer

(76) Inventor: Todd D. Farrell, Boise, ID (US)

Correspondence Address: Michael G. Fletcher;FLETCHER YODER, P.O. Box 692289, Houston, TX, 77269-2289, US

(21) Appl. No.: 11/218,994

(22) Filed: Sep. 1, 2005

(51) Int. Cl. G06F 12/00

(52) U.S. Cl. 711/118

(57) ABSTRACT

Techniques for dynamically selecting an input buffer in a memory device are provided. A plurality of buffers may receive a signal to be buffered. A buffer controller may communicate with the plurality of buffers in such a manner that it may select which of the input buffers will buffer the signal based on the memory device's mode of operation. The buffer controller may select a LVCMOS type input buffer to conserve power when the memory device enters a mode of operation that permits a slower response to a signal, and the buffer controller may select a SSTL type input buffer when the memory device enters a mode of operation demanding a quicker response to a signal.

### BACKGROUND OF THE INVENTION

1. Field Of The Invention

The present invention relates generally to memory devices and, more specifically, to techniques for dynamically selecting an input buffer in a memory device.

2. Description Of The Related Art

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

Processing speeds, system flexibility, and size constraints are typically considered by design engineers tasked with developing computer systems and system components. Computer systems typically include a plurality of memory devices which may be used to store programs and data and which may be accessible to other system components such as processors or peripheral devices. Typically, memory devices are grouped together to form memory modules such as dual-inline memory modules (DIMMs). Computer systems may incorporate numerous modules to increase the storage capacity of the system.

Typically, the memory devices communicate with other components within the computer system. For example, a processor may send an instruction to the memory device requesting data stored in a particular address. The memory device may then retrieve that data and send it to a memory controller, which forwards the data to the processor. In another example, the processor may instruct the memory device, through the memory controller, to store data in a particular address. In yet another example, a memory controller or a processor may send a clock enable (CKE) signal to instruct a memory device when to disregard the system clock that synchronizes the operations of the various devices in a computer. Thus, the processor, memory controller, and memory all may communicate with one another to coordinate various system requests and functions.

Often, the various devices within a computer communicate by actuating and sensing discrete changes in the voltage of one or more common nodes. Returning to the CKE signal example, the signaling device may raise the voltage of a common node, e.g. one to which a clock enable (CKE) pin on the memory device connects, to signal the memory device to disregard the system clock. To communicate the opposite instruction and direct the memory device to synchronize its operations with the system clock, the signaling device may lower the voltage applied to the CKE pin. Thus, by changing the voltage applied to one lead of the memory device between two discrete levels, the signaling device may transmit instructions to the memory device.

Typically, to facilitate communication between devices, an input buffer detects the voltage on a common node and determines which of the discrete voltage levels is being transmitted to the device. For example, in a binary system, an input buffer within a memory device may sense the voltage applied to its CKE pin and signal other parts of the memory device that the value being transmitted is either high or low. Thus, the CKE input buffer may function like a trigger for those portions of the memory device that respond to instructions transmitted through the CKE pin by categorizing the actual voltage applied to a device into one of the expected discrete voltage values. Accordingly, it may be important for the input buffer to accurately and quickly discern signals transmitted by other devices.

Computer component designers often make tradeoffs between speed and other constraints, such as power consumption, when selecting an input buffer. For example, to obtain higher speed performance, a designer might choose a stub series terminated logic (SSTL) type input buffer, which can quickly detect signals by comparing the signal voltage against a reference voltage. However, designers pay a price in terms of power consumption for choosing a SSTL input buffer: maintaining the reference voltage consumes power and generates heat that the system must dissipate. On the other hand, a designer might choose a low voltage complimentary metal oxide semiconductor (LVCMOS) type input buffer. These buffers do not require a reference voltage, but they often require larger, and more slowly propagated, changes in the signal voltage to register a transition. Consequently, a LVCMOS input buffer offers lower performance in terms of speed but better performance in terms of power consumption. Thus, in this instance, a designer may be forced to choose between optimizing a device for speed and optimizing a device for power consumption.

The optimal input buffer for some computer components depends on the type of task that computer component is performing at a given instant. For example, some tasks performed by a memory device do not require high-speed communication with other devices. Thus, for these tasks, a LVCMOS input buffer may provide the better tradeoff between power and speed. On the other hand, some tasks performed by the same memory device might require high-speed communication with other devices. For these tasks, a SSTL type input buffer might provide a better trade off between power and speed. Thus, the optimal input buffer for a given computer component may change depending on the task that component is performing at any given instant.

However, computer components typically only enable one kind of input buffer for a given line of communication, or pin. Thus, once the type of input buffer is set during the design or manufacturing process, the characteristics of the component with respect to the speed and power tradeoffs associated with different types of input buffers are fixed. Designers are often forced to choose an input buffer that they know is sub-optimal for some of the tasks that the competent will perform. Undesirably, these components may operate at a slower speed or consume more power than they would were designers able to dynamically choose an input buffer based on the type of task a component is performing.

Embodiments of the present invention may address one or more of the problems set forth above.

### BRIEF SUMMARY

Techniques for dynamically selecting an input buffer in a memory device are provided. A plurality of buffers may receive a signal to be buffered. A buffer controller may communicate with the plurality of buffers in such a manner that it may select which of the input buffers will buffer the signal. The buffer controller may select a buffer based on the memory device's mode of operation. In certain exemplary embodiments, the buffer controller may communicate with a mode register configured to make this selection, or the buffer controller may select a buffer in response to an externally generated signal. In certain embodiments, the buffer controller may select a LVCMOS type input buffer to conserve power when the memory device enters a mode of operation that permits a slower response to a signal, and the buffer controller may select a SSTL type input buffer when the memory device enters a mode of operation demanding a quicker response to a signal.

### BRIEF DESCRIPTION OF THE DRAWINGS

Advantages of the invention may become apparent upon reading the following detailed description and upon reference to the drawings, in which:

FIG. 1 illustrates a block diagram of an exemplary processor-based system in accordance with embodiments of the present invention;

FIG. 2 illustrates an exemplary memory sub-system in accordance with embodiments of the present invention;

FIG. 3 illustrates an exemplary memory module, which may be fabricated in accordance with embodiments of the present invention;

FIG. 4 illustrates an exemplary memory device, which may be fabricated in accordance with embodiments of the present invention;

FIG. 5 illustrates an exemplary dynamic input buffer, which may be fabricated in accordance with embodiments of the present invention;

FIG. 6 is a flow chart depicting operation of one embodiment of the present invention;

FIG. 7a is a graph exemplifying a typical voltage transition designed to signal a device incorporating a SSTL type input buffer; and

FIG. 7b is a graph exemplifying a typical voltage transition to signal a device incorporating a LVCMOS type input buffer.

### DETAILED DESCRIPTION OF SPECIFIC EMBODIMENTS

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming but would nevertheless be a routine undertaking of design, fabrication, and manufacture for those of ordinary skill having the benefit of this disclosure.

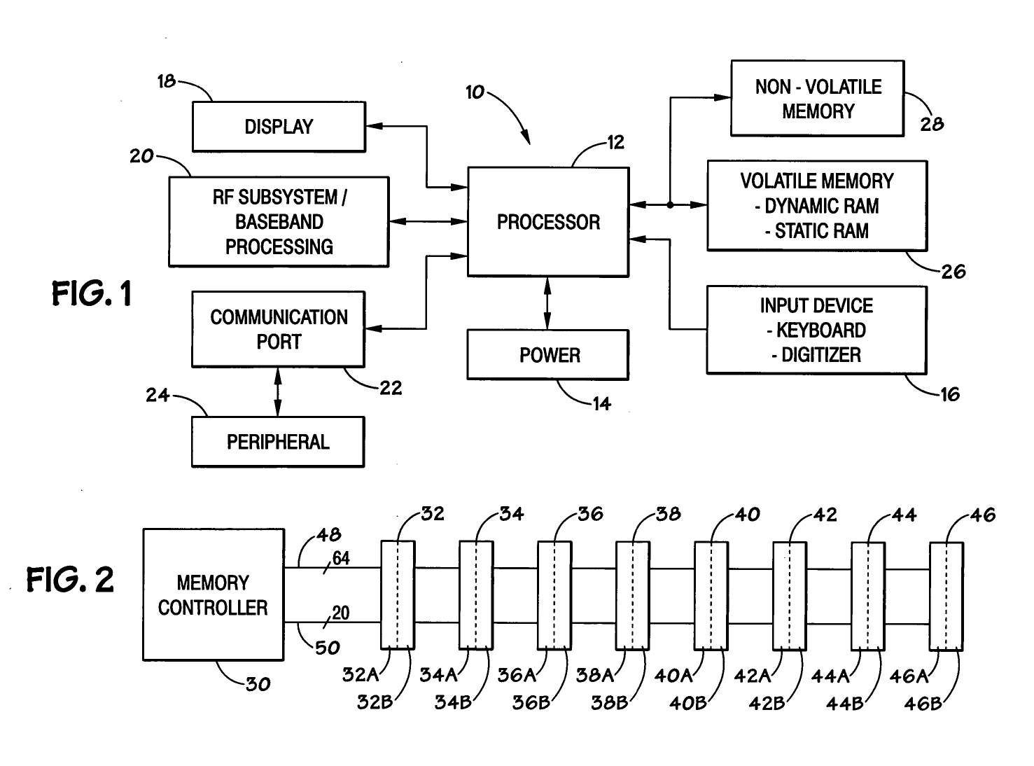

Turning now to the drawings, FIG. 1 depicts an exemplary processor-based system, generally designated by reference numeral 10, with a block diagram. The system 10 may be any of a variety of types such as a computer, pager, cellular phone, personal organizer, control circuit, etc. In a typical processor-based system, one or more processors 12, such as a microprocessor, control the processing of system functions and requests in the system 10.

The system 10 typically includes a power supply 14. For instance, if the system 10 is a portable system, the power supply 14 may advantageously include permanent batteries, replaceable batteries, and/or rechargeable batteries. The power supply 14 may also include an AC adapter, so the system 10 may be plugged into a wall outlet, for instance. The power supply 14 may also include a DC adapter such that the system 10 may be plugged into a vehicle cigarette lighter, for instance.

Various other devices may be coupled to the processor 12 depending on the functions that the system 10 performs. For instance, a user interface 16 may be coupled to the processor 12. The user interface 16 may include buttons, switches, a keyboard, a light pen, a mouse, and/or a voice recognition system, for instance. A display 18 may also be coupled to the processor 12. The display 18 may include an LCD, a CRT display, a DLP display, an OLED display, LEDs, and/or an audio display, for example. Furthermore, an RF sub-system/baseband processor 20 may also be couple to the processor 12. The RF sub-system/baseband processor 20 may include an antenna that is coupled to an RF receiver and to an RF transmitter (not shown). One or more communication ports 22 may also be coupled to the processor 12. The communications port 22 may be adapted to be coupled to one or more peripheral devices 24 such as a modem, a printer, a computer, or to a network, such as a local area network, remote area network, intranet, or the Internet, for instance.

The processor 12 generally controls the system 10 by implementing software programs stored in the memory. The memory is operably coupled to the processor 12 to store and facilitate execution of various programs. For instance, the processor 12 may be coupled to the volatile memory 26 which may include Dynamic Random Access Memory (DRAM) and/or Static Random Access Memory (SRAM). The volatile memory 26 is typically quite large so that it can store dynamically loaded applications and data. As described further below, the volatile memory 26 may be configured in accordance with embodiments of the present invention.

The processor 12 may also be coupled to non-volatile memory 28. The non-volatile memory 28 may include a read-only memory (ROM), such as an EPROM, and/or flash memory to be used in conjunction with the volatile memory. The size of the ROM is typically selected to be just large enough to store any necessary operating system, application programs, and fixed data. Additionally, the non-volatile memory 28 may include a high capacity memory such as a tape or disk drive memory.

FIG. 2 generally illustrates a block diagram of a portion of a memory sub-system, such as the volatile memory 26. A memory controller 30 is generally provided to facilitate access to storage devices in the volatile memory. The memory controller 30 may receive requests to access the storage devices via one or more processors, such as the processor 12, via peripheral devices, such as the peripheral device 24, and/or via other systems. The memory controller 30 is generally tasked with facilitating the execution of the requests to the memory devices and coordinating the exchange of information, including configuration information, to and from the memory devices.

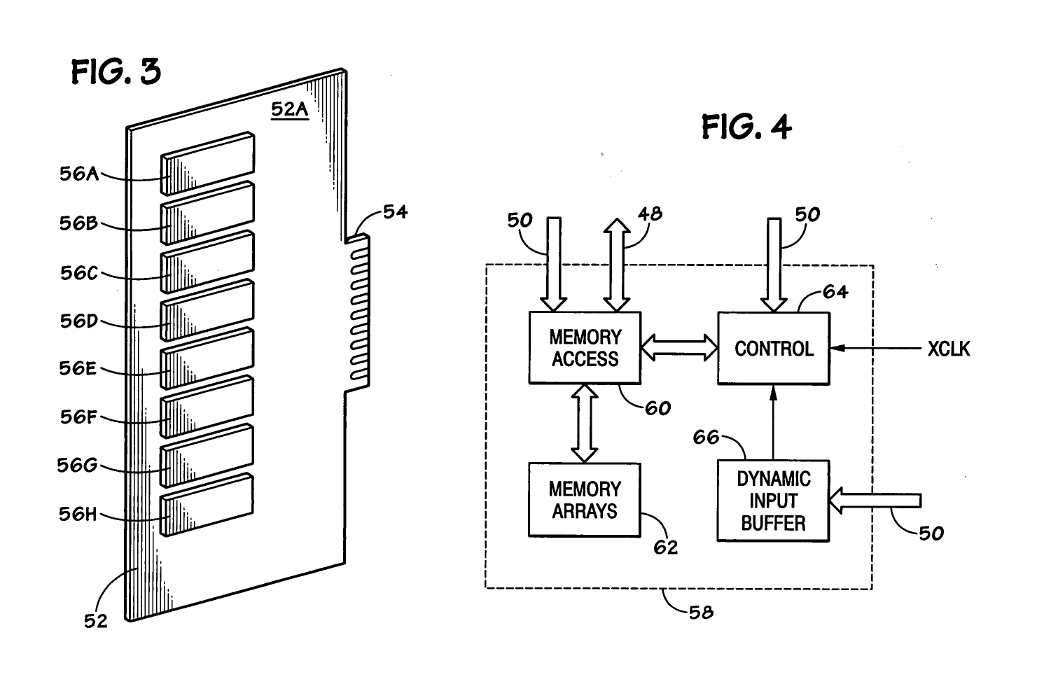

The memory sub-system may include a plurality of slots 32-46. Each slot 32-46 is configured to operably couple a memory module, such as a dual-inline memory module (DIMM), to the memory controller 30 via one or more memory buses. Each DIMM generally includes a plurality of memory devices such as dynamic random access memory (DRAM) devices capable of storing data, as described further below with reference to FIG. 3. As described further below, each DIMM has a number of memory devices on each side of the module. Each side of the module may be referred to as a “rank.” Accordingly, each slot 32-46 is configured to receive a single DIMM having two ranks. For instance, the slot 32 is configured to receive a DIMM having ranks 32A and 32B, the slot 34 is configured to receive a DIMM having ranks 34A and 34B, and so forth. In the present exemplary embodiment, each of the eight memory slots 32-46 is capable of supporting a module comprising eight individual memory devices on each rank 32A/B-46A/B, as best illustrated with respect to FIG. 3, described further below.

Referring again to FIG. 2, the memory buses may includes a memory data bus 48 to facilitate the exchange of data between each memory device on the DIMMs and the memory controller 30. The memory data bus 48 comprises a plurality of single bit data buses each coupled from the memory controller 30 to a memory device. In one embodiment of the volatile memory 26, the memory data bus 48 may include 64 individual data buses. Further, the memory data bus 48 may include one or more individual buses to each memory rank 32A/B-46A/B which may be used for ECC error detection and correction. As can be appreciated by those skilled in the art, the individual buses of the memory data bus 48 will vary depending on the configuration and capabilities of the system 10.

The volatile memory 26 also includes a command bus 50 on which address information such as command address (CA), row address select (RAS#), column address select (CAS#), write enable (WE#), bank address (BA), chip select (CS#), clock enable (CKE), and on-die termination (ODT), for example, may be delivered for a corresponding request. Further, the command bus 50 may also be used to facilitate the exchange of configuration information at boot-up. As with the memory data bus 48, the command bus 50 may comprise a plurality of individual command buses. In the present embodiment, the command bus 50 may include 20 individual buses. As previously described with reference to the memory data bus 48, a variety of embodiments may be implemented for the command bus 50 depending on the system configuration.

FIG. 3 illustrates an exemplary memory module 52, such as a DIMM, that may be inserted into one of the memory slots 32-46 (FIG. 2). In the present exemplary view, one side of the memory module 52 is illustrated, and generally designated as the rank 52A.

As previously discussed, the memory module 52 may include two ranks 52A and 52B. The rank 52A includes a plurality of memory devices 56A-56H, such as dynamic random access memory (DRAM) devices, which may be used for storing information. As will be appreciated, the second opposing side of the memory module 52 (52B, not shown) also includes a number of memory devices. The memory module 52 may include an edge connector 54 to facilitate mechanical coupling of the memory module 52 into one of the memory slots 32-46. Further, the edge connector 54 provides a mechanism for electrical coupling to facilitate the exchange of data and control signals from the memory controller 30 to the memory devices 56A-56H (and the memory devices on the second rank) on the memory module 52.

FIG. 4 depicts a block diagram of an exemplary memory device 58 in accordance with the present invention, such as memory devices 56A-56H illustrated in FIG. 3. Through the data bus 48 illustrated in FIG. 2, the memory device 58 may receive and send data. Additionally, an external system clock (XCLK) signal may synchronize the operation of the memory device 58 with other devices in the system 10. In the exemplary embodiment of FIG. 4, a memory access block 60 receives addresses and sends and receives data. Among other things, the memory access block 60 may accept an address through the command bus 50, access the appropriate memory cells within a memory array 62, and return the stored data through the data bus 48 or write data on the data bus 48 to the memory array 62. The memory access block 60 may include row and column address buffers, row and column decoders, sense amplifiers, and data input and output buffers. The memory access block 60 interfaces with the memory arrays 62, which may include a plurality of memory cells arranged in rows and columns. In one embodiment, a memory cell stores data in the charge state of a capacitor accessed through a transistor unique to that memory cell.

As depicted in FIG. 4, a control block 64 may direct the operation of the memory access block 60 and the memory arrays 62. In this embodiment, the control block 64 accepts commands from other devices, such as the memory controller 30 or processor 12, that may be sent through the command bus 50 (see FIGS. 1 and 2). Additionally, the control block 64 may accept an external system clock signal (XCLK) and synchronize certain operations of the memory device 58 with the operation of other devices within the system. In some situations, the control block 64 may also accept a clock enable (CKE) signal from an external device, which may instruct it to disregard the XCLK signal in response to a low CKE signal.

Certain individual busses may communicate with the memory device 58 of FIG. 4 through a dynamic input buffer 66 manufactured in accordance with the present technique. As used herein, a “dynamic input buffer” may be employed to select the type of input buffer used to process a signal during the operation of the memory device, i.e. the type of input buffer that will receive a signal is not fixed during the manufacturing process. By way of example, this embodiment includes a dynamic input buffer 66 that senses the CKE signal. However, other embodiments may include dynamic input buffers directed toward other individual busses. The dynamic input buffer 66 may be integrated within the memory device 58, or in other embodiments, the dynamic input buffer 66 may be external to the memory device 58, e.g., in series with a signaling device. The dynamic input buffer 66 may receive a signal or signals from other devices and, after appropriate processing of the signal, transmit those signals on to the portions of the device to which the signals are directed, as discussed further below.

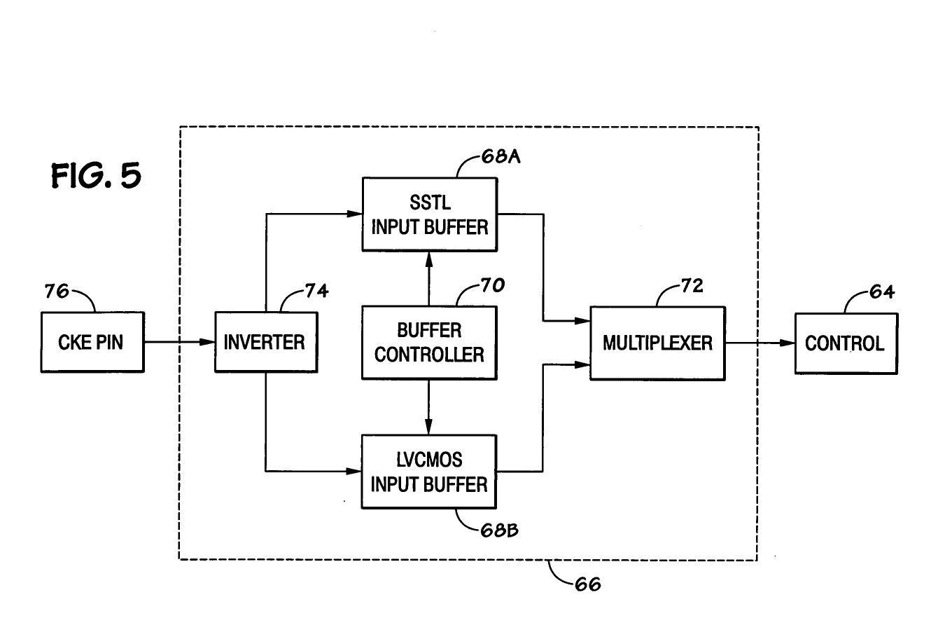

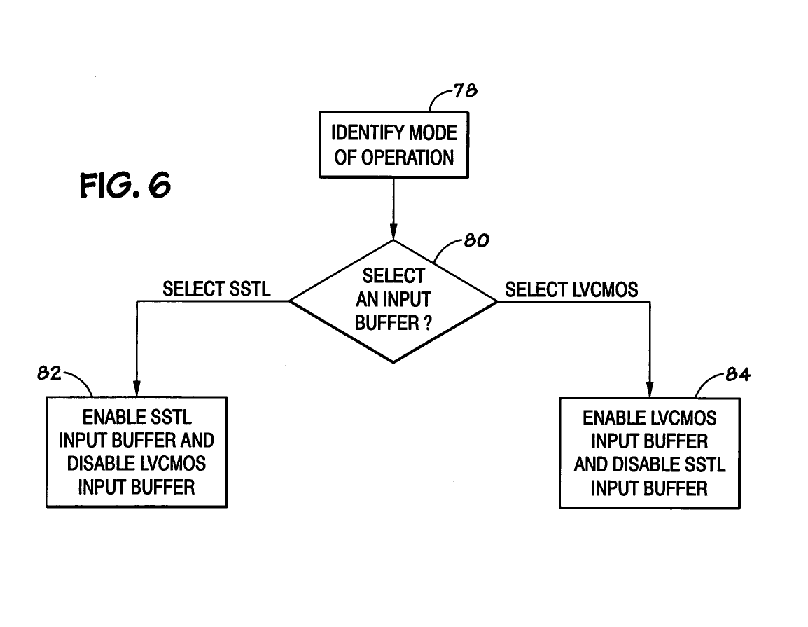

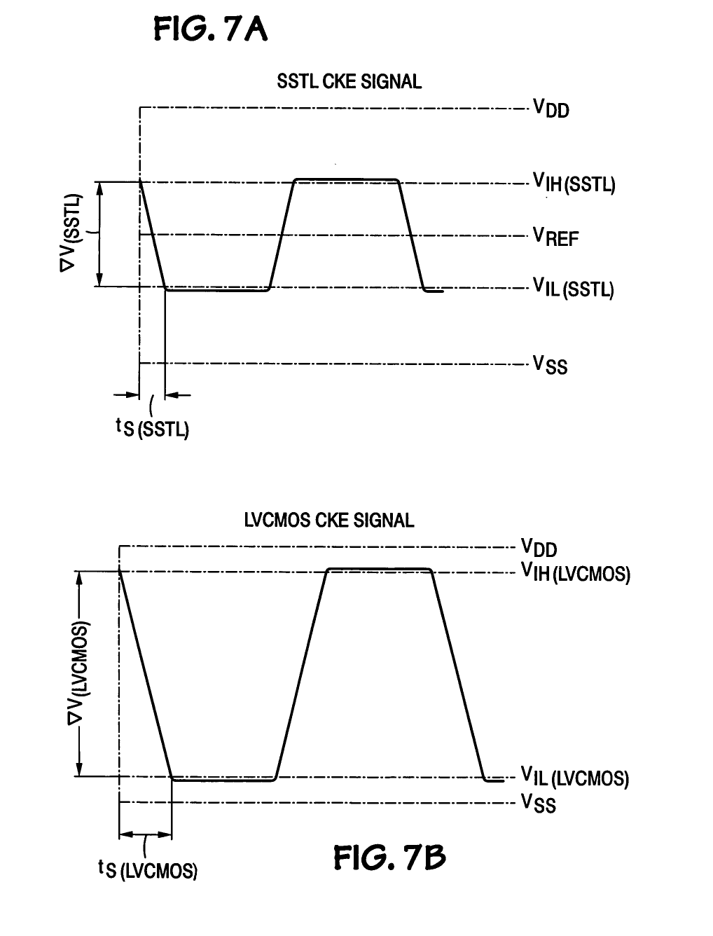

Turning now to FIG. 5, a block diagram of an exemplary dynamic input buffer 66 in accordance with embodiments of the present invention is illustrated. The dynamic input buffer 66 may buffer a signal from some other device that is transmitted through a pin 76. The pin 76 may include any component adapted to receive a signal from some other device and may be configured to receive a CKE signal. The dynamic input buffer 66 may include two or more buffers 68A-68B, a buffer controller 70, a multiplexer 72, and an inverter 74. In the present exemplary embodiment, the dynamic input buffer 66 may include a SSTL input buffer 68A and a LVCMOS buffer 68B. As described further below with respect to FIGS. 6, 7A and 7B, the dynamic input buffer 66 advantageously provides a mechanism for selecting among two or more input buffers, depending on the application. In the present embodiment, the buffers 68A-68B communicate with the inverter 74 at their input and each communicate separately with the multiplexer 72 at their output. The inverter 74 may receive the signal to be buffered, and the multiplexer 72 may transmit the buffered signal on to the control circuitry 64 (FIG. 4).

Also communicating with the buffers 68A-68B, a buffer controller 70 may select between the buffers 68A-68B. When the buffer controller 70 selects a buffer, it may disable other unselected buffers and enable the selected buffer. For example, the buffer controller 70 may select buffer 68A by enabling buffer 68A and disabling buffer 68B. When selecting among more than two buffers, the buffer controller 70 may disable all unselected buffers and enable only the selected buffer. When disabling a buffer, the buffer controller 70 may also disable power supplied to that buffer or a reference voltage to conserve energy and limit the amount of heat that the device may need to dissipate.

In operation, the buffer controller 70 may employ the exemplary method of selecting a buffer illustrated by the flow chart of FIG. 6. Initially, the buffer controller 70 may identify the memory device's 58 mode of operation, as illustrated by block 78. Next, as illustrated by block 80, the buffer controller 70 may select an input buffer. If a SSTL type input buffer is selected, for example, the buffer controller may then enable the SSTL type input buffer and disable the LVCMOS type buffer, as depicted by block 82. Alternatively, if a LVCMOS type buffer is selected, the buffer controller may enable the LVCMOS type buffer and disable the SSTL type input buffer. Thus, by employing the present exemplary method, the buffer controller 70 may select an input buffer.

As illustrated in the flow chart of FIG. 6, buffer selection may occur dynamically. The selection depicted in block 80 may be based on the type of task the memory device 58 is performing, has performed, or is about to perform. In some embodiments, buffer selection may be based on the type of task the system as a whole or other devices within the system are performing, are about to perform, or have performed. In other embodiments, the buffer selection may be based on a temperature or the battery power remaining in the device or the system.

The buffer controller 70 may be preprogrammed to dynamically select certain buffers or combinations of buffers. In one embodiment, the buffer controller 70 may be preprogrammed by setting mode registers to indicate which buffer to select based on the type of task the memory device is performing. For example, the mode registers may be programmed to select buffer 68B when entering a self refresh or power down mode and to select buffer 68a when entering other modes of operation.

In another embodiment, the buffer controller 70 may receive externally generated instructions to select a certain buffer or a combination of buffers. For example, the buffer controller 70 may receive instructions from the memory controller or processor indicating which buffer to choose. In yet another embodiment, the buffer controller 70 may select buffers or combinations of buffers based on a combination of preprogrammed criteria and commands generated external to the memory device. For example, an external command may select among different sets of preprogrammed mode registers or external commands may change the programming of the mode registers.

Each buffer, 68A and 68B in the exemplary embodiment of FIG. 5, when enabled, may sense the transmitted signal and indicate to other portions of the memory device 58 the value being transmitted. For example, in a binary digital system, the buffer may receive a signal in the form of a voltage or current and indicate if the signal transmitted is a high or low value. Thus, in a digital system, the enabled buffer may categorize the transmitted signal into one of the expected discrete signal values used to transmit information in a digital system.

In the embodiment depicted by FIG. 5, the buffer 68A may be a stub series terminated logic (SSTL) type buffer. This buffer 68A may compare a signal from another device against a reference voltage (V_{REF}) to determine the value being transmitted. FIG. 7a illustrates the operation of a SSTL buffer in a binary digital system. The buffer 68A may register a voltage near V_{IH(SSTL)} as a high signal and a voltage near V_{IL(SSTL)} as a low signal. In this embodiment, V_{IH(SSTL)} and V_{IL(SSTL)} are defined in terms of a voltage differential from V_{REF}. Thus, when V_{REF} shifts due to process variation and temperature changes, the value of V_{IH(SSTL)} and V_{IL(SSTL)} may change as well, eliminating some noise that may interfere with the detection of signals. Advantageously, the difference between V_{IH(SSTL)} and V_{IL(SSTL)} may be relatively small due to V_{REF} eliminating this noise, allowing for quick signal propagation and detection. FIG. 7a illustrates this benefit, depicting the difference between V_{IH(SSTL)} and V_{IL(SSTL)} as ΔV_{(SSTL)} and depicting the time a signal takes to transition from V_{IH(SSTL)} to V_{IL(SSTL)} as t_{s(SSTL)}. As will be illustrated heuristically by comparing the present figure with the following figure, a smaller voltage swing may occur faster than a larger one, thus t_{s(SSTL)} may be faster in a SSTL buffer 68A than in a buffer designed to detect larger voltage swings. However, the use of a reference voltage may increase the power consumed by the memory device due to leakage from circuits directed toward maintaining and sensing V_{REF}. Thus, in some embodiments, the SSTL buffer 68A is enabled when high-speed transmission and registration of signals is critical and disabled when power consumption is of greater concern. When disabled, either the buffer controller 70 or an external device such as the memory controller or processor may open the V_{REF} line to the SSTL buffer 68A to conserve power.

Complimenting the SSTL buffer 68A, the embodiment of FIG. 5 may also include a low voltage CMOS (LVCMOS) buffer 68B. Unlike a SSTL buffer, a LVCMOS buffer 68B may conserve power by not employing a reference voltage. Instead, this buffer may rely on a larger voltage swing between V_{IH(LVCMOS)} and V_{IL(LVCMOS)}, as illustrated by FIG. 7b. Again, a voltage near V_{IH(LVCMOS)} is registered as a high signal and a voltage near V_{IL(LVCMOS)} is registered as a low signal. By distinguishing between voltages with a larger differential, the LVCMOS buffer 68B may avoid false signals from process variation and temperature changes while correctly registering a transmitted signal. However, because signaling the LVCOMs buffer 68B may require a larger voltage swing, signals may propagate slower. Thus, because the difference between V_{IH(LVCMOS)} and V_{IL(LVCMOS)} (depicted as ΔV_{(LVCMOS)} in FIG. 7a) may be larger than the voltage differential employed by devices communicating with the SSTL input buffer 68A, the time a signal takes to transition from one value to another (depicted as t_{s(LVCMOS)}) may be longer. Consequently, in the present embodiment, the buffer controller 70 may enable the LVCMOS buffer 68B to conserve power when high-speed signal transmission is less critical.

Advantageously, the buffer controller 70 may dynamically select between the buffers 68A-68B of FIG. 5 to optimize both power consumption and speed. When the dynamic input buffer 66 must respond quickly to a signal, the buffer controller 70 may enable the SSTL buffer 68A and disable the LVCMOS buffer 68B. Later, when proper device operation does not depend on a quick response to a signal, the buffer controller 70 may enable the LVCMOS buffer 68B while conserving power by disabling the SSTL buffer 68A along with V_{REF}. For example, with respect to the CKE dynamic input buffer 66 of FIG. 5, the buffer controller 70 may select the LVCMOS buffer 68B when the memory device 58 is entering a power-down mode, a self-refresh mode, or any mode in which the memory device 58 will function properly with a slower buffer response. Thus, by selecting the buffer that consumes the least power while still meeting the speed requirements of the task at hand, the dynamic input buffer 66 of the present embodiment may reduce power consumption.

While the present embodiment depicts the buffer controller 70 communicating directly with the buffers, in other embodiments the buffer controller may communicate directly with the multiplexer 72. Thus, rather than directly enabling and disabling the buffers, the buffer controller may direct the multiplexer 72 to only transmit signals from certain buffers.

In still other embodiments, the sequence and identity of components depicted in FIG. 5 may be further modified. For example, the multiplexer 72 may be electrically interposed between the buffers and the signaling device. In such an embodiment, the multiplexer 72 may be located before or after the inverter 74 with respect to the direction of information flow. Similarly, another embodiment may forgo the inverter 74 or place the inverter after the buffers 68A-68B or after the multiplexer 72 with respect to the direction of information flow. In one embodiment, a decoder may be substituted for the multiplexer 72 and the control signals modified accordingly. In another embodiment, the buffers may be in series and configured to act as a closed circuit when not enabled.

Moreover, devices other than just DRAM may employ embodiments of the present invention. For example, flash RAM, flash ROM, processors, memory controllers, DSP device, ASIC, or any other integrated circuit with an input or output buffer may benefit from the present technique.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A device comprising:
a first type of input buffer adapted to receive a signal;
a second type of input buffer adapted to receive the signal; and
a buffer controller coupled to each of the first and second types of input buffers and configured to select one of the first type of input buffer and the second type of input buffer.

2. The device of claim 1, wherein signal is a clock enable signal.

3. The device of claim 1, wherein the device comprises a dynamic random access memory device.

4. The device of claim 1, wherein the buffer controller comprises a mode register adapted to select among the buffers based on the type of task the device is performing.

5. The device of claim 1, wherein the buffer controller is adapted to select among the buffers in response to a control signal generated externally to the device.

6. The device of claim 1, wherein the first type of input buffer comprises a low voltage CMOS (LVCMOS) type buffer and the second type of input buffer comprises a stub series terminated logic (SSTL) type buffer.

7. The device of claim 6, wherein the buffer controller comprises a mode register adapted to select the LVCMOS type buffer when the device enters a power down mode or a self refresh mode and further adapted to select the SSTL type buffer when not in the power down mode or the self refresh mode.

8. The device of claim 1, further comprising a multiplexer coupled to each of the first and second types of input buffers.

9. A computer system comprising:
a processor;
a memory system coupled to the processor and comprising:
a memory device comprising:
a dynamic input buffer adapted to buffer a signal received by the memory device, wherein the dynamic input buffer comprises:
a first type of input buffer configured to buffer the signal; and
a second type of input buffer configured to buffer the signal.

10. The computer system of claim 9, wherein the dynamic input buffer comprises a LVCMOS type buffer and a SSTL type buffer.

11. The computer system of claim 9, wherein the dynamic input buffer comprises a buffer controller configured to select one of the first type of input buffer and the second type of input buffer.

12. The computer system of claim 10, wherein the dynamic input buffer comprises a mode register coupled to the LVCMOS type buffer and the SSTL type buffer and adapted to dynamically select a buffer.

13. The computer system of claim 9, wherein the memory device comprises a clock enable (CKE) pin, and wherein the dynamic input buffer is coupled to the CKE pin and configured to receive a CKE signal.

14. The computer system of claim 13, wherein the memory device is a dynamic access memory device (DRAM), and wherein the dynamic input buffer comprises:
a LVCMOS type buffer coupled to the CKE pin;
a SSTL type buffer coupled to the CKE pin and in parallel with the LVCMOS type buffer; and
a mode register coupled to the LVCMOS type buffer and the SSTL type buffer and adapted to dynamically select a buffer.

15. A system comprising:
a memory device comprising:
a pin;
a first type of input buffer coupled to the pin;
a second type of input buffer coupled to the pin; and
a buffer controller coupled to the first and second type of input buffers and configured to dynamically select one of the first type of input buffer and the second type of input buffer.

16. The system of claim 15, comprising a multiplexer coupled to the first and second types of input buffers.

17. The system of claim 16, wherein the first and second types of input buffers are coupled in series between the pin and the multiplexer and coupled in parallel with respect to one another.

18. The system of claim 15, wherein the first type of buffer comprises a LVCMOS type buffer and the second type of buffer comprises a SSTL type buffer.

19. The system of claim 15, wherein the pin is configured to receive a clock enable signal.

20. The system of claim 15, wherein the memory device is a DRAM.

21. The system of claim 15, wherein the memory device further comprises a mode register coupled to the buffer controller and adapted to dynamically select one of the first type of input buffer and second type of input buffer.

22. A method of dynamically selecting an input buffer comprising:
identifying a mode of operation of a memory device comprising a plurality of input buffers coupled to a pin; and
selecting at least one the plurality of input buffers based on the mode of operation of the memory device.

23. The method of claim 22 wherein selecting at least one of the plurality of input buffers comprises selecting one of a LVCMOS type buffer and a SSTL type buffer, and wherein the pin is adapted to receive a clock enable (CKE) signal.

24. The method of claim 23, wherein selecting comprises selecting the LVCMOS type buffer during a self-refresh mode of operation.

25. The method of claim 23, wherein selecting comprises selecting the LVCMOS type buffer during a power-down mode of operation.

26. The method of claim 23, wherein selecting comprises selecting the LVCMOS type buffer during a power-up mode of operation.

27. The method of claim 26, wherein selecting comprises selecting the SSTL type buffer after the LVCMOS type buffer during the power-up mode of operation.

28. The method of claim 23, wherein selecting comprises selecting the LVCMOS type buffer during a reset operation.
